(19) United States
(12) Patent Application Publication
(10) Pub. No.: US 2013/0059765 A1
(43) Pub. Date: Mar. 7, 2013

(54) BLEACHING AGENT PARTICLES COMPRISING SODIUM PERCARBONATE AND A BLEACH ACTIVATOR

(71) Applicants: Stefan Leininger, Langenselbold (DE); Harald Jakob, Hasselroth (DE); Ralph Overdick, Hofheim (DE)

(72) Inventors: Stefan Leininger, Langenselbold (DE); Harald Jakob, Hasselroth (DE); Ralph Overdick, Hofheim (DE)

(73) Assignee: Evonik Degussa GmbH, Essen (DE)

(21) Appl. No.: 13/643,174

(22) PCT Filed: Apr. 27, 2011
(86) PCT No.: PCT/EP2011/056607

§ 371 Date: Oct. 24, 2012

(30) Foreign Application Priority Data
Apr. 27, 2010 (DE) 102010028236.7

(51) Int. Cl. C11D 3/60; B05D 7/00; C09K 3/00

(52) U.S. Cl. 510/376; 252/186.25; 427/214; 427/213

(57) ABSTRACT

Bleach particles with a core of sodium percarbonate, an inner coating layer with at least 50% by weight of sodium sulfate in the form of thenardite or burkeite and an outer coating layer comprising a water-soluble binder and a perhydrolyzable N-acyl compound or O-acyl compound as bleach activator are storage-stable, are suitable for silo storage and can be transported and handled safely even in a hot and humid climate.

The invention relates to bleach particles which comprise sodium percarbonate and a bleach activator and have high storage stability.

Sodium percarbonate is used as bleach in cleaners and detergents. When using the cleaner, hydrogen peroxide is released from the sodium percarbonate as bleaching-active component. In order to enhance the bleaching effect at low temperatures, bleaching systems, in which sodium percarbonate is used together with a bleach activator, are mostly used in cleaners. The bleach activators used for this purpose are mostly N-acyl compounds and O-acyl compounds containing one or more perhydrolyzable acyl groups bonded to nitrogen or to oxygen, which react with the hydrogen peroxide released from the sodium percarbonate in an aqueous cleaner solution to give a peroxycarboxylic acid. Besides the perhydrolysis, hydrolysis also occurs, leading to the corresponding carboxylic acid instead of the peroxycarboxylic acid, in particular in alkaline cleaner solutions.

Both sodium percarbonate and the N-acyl compounds and O-acyl compounds used as bleach activators are moisture-sensitive and decompose in a cleaner preparation under the action of moisture. Consequently, sodium percarbonate and perhydrolyzable bleach activators are usually employed separately in cleaners in the form of in each case coated particles, in which the coating is intended to prevent action of moisture.

Since sodium percarbonate and the N-acyl compounds and O-acyl compounds used as bleach activators have very different densities and bulk densities, segregation of the particles of sodium percarbonate and bleach activator can occur in cleaners comprising sodium percarbonate particles and bleach activator particles, both during the production of the cleaner and in the packaged cleaner during transportation and use. As a consequence of this, the proportion of bleach and bleach activator desired for the bleach activation is no longer present when using the cleaner. A higher content of bleach and bleach activator is then required in the cleaner to ensure an adequate bleaching effect. It would therefore be desirable to add sodium percarbonate and bleach activator to the cleaner in the form of particles comprising both sodium percarbonate and bleach activator, in order to avoid segregation of sodium percarbonate and bleach activator and in order to avoid losses of bleach activator through hydrolysis during use. However, for all such particles, there is the problem of avoiding a premature reaction of sodium percarbonate with the bleach activator within the particle.

U.S. Pat. No. 5,458,801 describes particles which have a coating layer of a bleach activator and a water-soluble organic binder on a sodium percarbonate core coated with a borate. These particles are produced by granulating the sodium percarbonate particles coated with a borate with pulverulent bleach activator and molten binder. Granulation takes place in a mixer granulator using a chopper. An additional coating layer composed of a water-soluble high molecular weight substance can be applied to the particles obtained, where this coating layer can be applied by spraying on an aqueous solution of the high molecular weight substance in a fluidized bed.

WO 20077127641 describes cogranules comprising sodium percarbonate and a bleach activator which are produced by firstly granulating sodium percarbonate or a bleach activator with a molten binder and then producing the cogranules with the other component.

However, the prior art bleach particles comprising sodium percarbonate and a bleach activator have the disadvantage that they exhibit self-heating during storage, due to a decomposition of sodium percarbonate or a reaction of sodium percarbonate with the bleach activator, which is so extensive that they must not be stored in a silo for safety reasons. Moreover, these prior art bleach particles also have the disadvantage that they have a tendency towards caking during storage, which is likewise an obstacle to silo storage.

It has now been found that improved storage stability can be achieved for bleach particles, having a sodium percarbonate core and a coating layer comprising the bleach activator, by a coating layer of suitable composition positioned in between, which permits storage in silos.

The invention therefore provides bleach particles comprising a core which consists essentially of sodium percarbonate, an inner coating layer which comprises at least 50% by weight of sodium sulfate in the form of thenardite or burkeite, and an outer coating layer comprising a water-soluble binder and at least one bleach activator selected from perhydrolyzable N-acyl compounds and O-acyl compounds.

The invention also provides cleaners which comprise such bleach particles, and also a method for producing such bleach particles, which comprises a first step of spraying an aqueous solution comprising sodium sulfate onto particles consisting essentially of sodium percarbonate with simultaneous evaporation of water, and a second step of depositing an aqueous solution or dispersion of a water-soluble binder and particles of a bleach activator, selected from perhydrolyzable N-acyl compounds and O-acyl compounds, on the coated particles formed in the first step.

The bleach particles according to the invention comprise a core which consists essentially of sodium percarbonate, i.e. sodium carbonate perhydrate with the composition 2 Na₂CO₃.3 H₂O₂. Besides sodium percarbonate, the core can also comprise sodium carbonate, sodium hydrogencarbonate and mixed salts thereof, and also small amounts of known stabilizers for peroxygen compounds, such as, for example, magnesium salts, silicates, phosphates and/or chelate complexing agents. The fraction of sodium percarbonate in the core of the bleach particles according to the invention is preferably more than 70% by weight and particularly preferably more than 85% by weight, based on the mass of the core. The fraction of organic carbon compounds in the core is preferably less than 1% by weight, particularly preferably less than 0.1% by weight, based on the mass of the core.

In a preferred embodiment, the core comprises small amounts of additives which have a stabilizing effect on the active oxygen content, the fraction of stabilizing additives in the core being preferably less than 2% by weight, based on the mass of the core. The stability-increasing additives used are preferably magnesium salts, waterglass, stannates, pyrophosphates, polyphosphates and chelate complexing agents from the series of hydroxycarboxylic acid, aminocarboxylic acids, aminophosphonic acids, phosphonocarboxylic acids and hydroxyphosphonic acids, and alkali metal, ammonium or magnesium salts thereof. In a particularly preferred embodiment, the core comprises an alkali metal silicate in an amount of from 0.1 to 1% by weight, based on the mass of the core, as stabilizing additive, preferably waterglass with an SiO₂/Na₂O modulus in the range from 1 to 3. In the most preferred embodiment, the core also comprises a magnesium compound in an amount of from 50 to 2000 ppm of Mg²⁺, based on the mass of the core, in addition to this amount of alkali metal silicate. The evolution of heat by decomposition of the sodium percarbonate in the core during storage can be further reduced by adding the stabilizing additive.

The core of the bleach particles according to the invention can be produced by one of the known preparation processes for sodium percarbonate. A suitable preparation process for sodium percarbonate is the crystallization of sodium percarbonate from aqueous solutions of hydrogen peroxide and sodium carbonate, where the crystallization can be carried out either in the presence or in the absence of a salting-out agent, for which purpose reference is made by way of example to EP-A 0 703 190 and DE 2 744 574. Sodium percarbonate particles prepared by the crystallization process in the presence of a salting-out agent can also comprise small amounts of the salting-out agent used, such as e.g. sodium chloride. Likewise suitable is the fluidized-bed buildup granulation by spraying aqueous hydrogen peroxide solution and aqueous sodium carbonate solution onto sodium percarbonate seeds in a fluidized bed with simultaneous evaporation of water, reference being made by way of example to WO 95/06615. Furthermore, the reaction of solid sodium carbonate with an aqueous hydrogen peroxide solution and subsequent drying is also a suitable preparation process, reference being made by way of example to DE 196 08 000.

In a preferred embodiment, the bleach particles according to the invention have a core of essentially sodium percarbonate which is obtainable by fluidized-bed granulation from aqueous solutions of hydrogen peroxide and sodium carbonate. As a result of such a fluidized-bed granulation, a core is obtained which differs from the cores obtained by other preparation processes by virtue of a particularly dense, shell-like structure and a smoother surface. Bleach particles according to the invention, the core of which has been produced by fluidized-bed buildup granulation, exhibit a further significant improvement in storage stability and considerably lower evolution of heat compared with particles whose core has been produced by a different process.

Preferably, the core has a diameter in the range from 400 to 1600 μm, particularly preferably from 500 to 800 μm. By selecting a core diameter within this range, it is possible to avoid segregation of the bleach particles in granular cleaners, and to ensure high storage stability of the bleach particles.

In addition to the core, the bleach particles according to the invention also comprise an inner coating layer which comprises at least 50% by weight, preferably at least 75% by weight, of sodium sulfate in the form of thenardite or burkeite.

In a preferred embodiment, the inner coating layer comprises sodium sulfate and sodium carbonate in a weight ratio of from 95:5 to 75:25. Particularly preferably, the weight ratio of sodium sulfate and sodium carbonate is in the range from 95:5 to 80:20, most preferably in the range from 90:10 to 80:20. The joint fraction of sodium sulfate and sodium carbonate in the inner coating layer here is preferably at least 80% by weight, preferably at least 90% by weight. The sodium carbonate present in the coating layer is present here preferably to an extent of more than 80% in the form of burkeite with the composition Na₄(SO₄)₁₊ₙ(CO₃)₁₋ₙ, where n is from 0 to 0.5. The fraction of burkeite relative to other phases present in the bleach particles which comprise sodium carbonate can be determined by Rietveld analysis of powder X-ray diagrams of the bleach particles.

In a preferred embodiment, the inner coating layer additionally comprises 0.1 to 1% by weight of sodium silicate, particularly preferably 0.2 to 0.5% by weight of sodium silicate. The sodium silicate is preferably a water-soluble sodium silicate, in particular a waterglass. The storage stability of the bleach particles according to the invention can be further improved by adding small amounts of sodium silicate.

In another preferred embodiment, the inner coating layer comprises sodium sulfate in the form of a high-temperature phase of sodium sulfate and/or a high-temperature phase of a double salt with the composition Na₄(SO₄)₁₊ₙ(CO₃)₁₋ₙ, where n is from 0 to 0.5. The presence of the high-temperature phases can be determined on the basis of powder X-ray diagrams of the bleach particles. Coating layers which comprise sodium sulfate in the form of a high-temperature phase can be prepared as described in EP 1 903 098.

The weight fraction of the inner coating layer is preferably 2 to 25%, particularly preferably 2 to 10% and most preferably 4 to 7%, in each case based on the mass of the bleach particle. The inner coating layer is preferably formed such that it covers the material underneath to an extent of more than 95%, preferably to an extent of more than 98% and in particular completely.

Due to the composition of the inner coating layer, a reaction of sodium percarbonate from the core and bleach activator from the outer coating layer is effectively prevented and such a small release of heat during storage is brought about that the bleach particles according to the invention can be stored safely in a silo and can also be transported and handled in a hot and humid climate. Moreover, due to its composition, the inner coating layer is particularly insensitive to mechanical stresses, meaning that the high storage stability is not adversely affected by mechanical stress on the bleach particles as occurs during pneumatic conveying or during storage in a tall silo, and the property of a small release of heat during storage is retained.

In addition to the core and the inner coating layer, the bleach particles according to the invention also comprise an outer coating layer which comprises a water-soluble binder and which comprises at least one bleach activator selected from perhydrolyzable N-acyl compounds and O-acyl compounds. Preferably, the outer coating layer comprises the bleach activator in the form of discrete particles, which preferably have a mass-based average particle size in the range from 0.1 to 400 μm, particularly preferably from 1 to 200 μm. By arranging the bleach activator in the outer coating layer in the form of such particles, it is simultaneously possible to achieve high stability against hydrolysis during storage and rapid reaction of the bleach activator to give the percarboxylic acid when using the bleach particles according to the invention.

Suitable bleach activators are perhydrolyzable N-acyl compounds and O-acyl compounds which react in an aqueous medium with hydrogen peroxide to give a peroxycarboxylic acid. Suitable are most notably polyacylated alkylenediamines, in particular tetraacetylethylenediamine (TAED); acylated triazine derivatives, in particular 1,5-diacetyl-2,4-dioxohexahydro-1,3,5-triazine (DADHT); acylated glycolurils, in particular tetraacetylglycoluril (TAGU); N-acylimides, in particular N-nonanoylsuccinimide (NOSI); acylated phenolsulfonates, in particular n-nonanoyl- or isononanoyloxybenzenesulfonate (n- or iso-NOBS); carboxylic acid anhydrides, such as phthalic anhydride; acylated polyhydric alcohols, such as ethylene glycol diacetate, 2,5-diacetoxy-2,5-dihydrofuran, acetylated sorbitol and mannitol and acylated sugars, such as pentaacetylglucose; enol esters; and N-acylated lactams, in particular N-acylcaprolactams and N-acylvalerolactams. Tetraacetylethylenediamine or the sodium salt of 4-nonanoyloxybenzenesulfonic acid are preferably used as bleach activator, most preferably the bleach activator is tetraacetylethylenediamine.

Suitable water-soluble binders for the outer coating layer are both inorganic and organic binders which dissolve in water or an alkaline cleaner solution. Preference is given to binders which, even upon prolonged storage, exhibit no reaction with the bleach activator or with hydrogen peroxide released from the core.

Preferred inorganic binders are water-soluble alkali metal silicates, particularly preferably the water-soluble sodium silicates referred to as waterglass, where waterglass with a modulus of from 1.8 to 2.5 is most preferred.

Preferred organic binders are vinyl polymers with carboxyl groups, in particular polymers of acrylic acid and methacrylic acid and copolymers of acrylic acid with methacrylic acid, acrolein or vinyl monomers containing sulfonic acid groups, and also alkali metal salts thereof, in particular sodium salts, where the carboxyl groups may be reacted completely or partially to give the alkali metal salt. These preferred binders can additionally take on the function of a cobuilder when the bleach particles according to the invention are used in a cleaner.

In addition, however, other water-soluble polymers, such as polyvinyl alcohols and polyvinylpyrrolidones, can also be used as binders.

The bleach particles according to the invention comprise the bleach activator and the binder preferably in a weight ratio of bleach activator to binder in the range from 20:1 to 1:1, particularly preferably 10:1 to 4:1.

The bleach particles according to the invention comprise sodium percarbonate and bleach activator preferably in a weight ratio of bleach activator to sodium percarbonate in the range from 1:1 to 1:9, particularly preferably in the range from 1:3 to 1:5. When using a cleaner, which comprises the bleach particles according to the invention, a high yield of percarboxylic acid and thus a high bleaching effect, based on the amount of sodium percarbonate and bleach activator used, can be achieved by such a selection of the weight ratio.

In addition to the inner and the outer coating layer, the bleach particles according to the invention can also comprise one or more further coating layers, which then can be arranged between the core and the inner coating layer, as well as between the inner and the outer coating layer or outside the coating layer according to the invention. Preferably, the inner coating layer is positioned directly on the core of essentially sodium percarbonate, and the outer coating layer is located directly on the inner coating layer.

A sharp boundary, at which the composition changes suddenly, may exist between the coating layers and also between the innermost coating layer and the core. As a rule, however, a transition zone will in each case form between the individual coating layers, and also between the innermost coating layer and the core, said transition zone comprising the components of the two adjacent layers. Such transition zones are formed, for example, by applying a coating layer in the form of an aqueous solution where, at the start of the layer buildup, some of the layer underneath is partially dissolved, giving a transition zone which comprises the constituents of both layers. In the preferred embodiment in which the inner coating layer is located directly on the core of essentially sodium percarbonate, a transition layer can thus form between the core and the inner coating layer which comprises sodium sulfate, sodium carbonate, sodium hydrogencarbonate and sodium percarbonate, and also mixed salts of these components.

In a preferred embodiment, the bleach particles according to the invention have an additional coating layer which is positioned on top of the outer coating layer and comprises at least 50% by weight, preferably at least 75% by weight, of sodium sulfate in the form of thenardite or burkeite. The weight fraction of this additional coating layer is preferably 2 to 25%, particularly preferably 2 to 10%, based on the mass of the bleach particle. Bleach particles with such an additional coating layer exhibit no or only low caking under the action of pressure and can therefore be stored safely in a silo without leading to caking in the silo. Moreover, the additional coating layer brings about an improvement in the stability of the bleach particle in a cleaner preparation and avoids a loss in bleaching effect during the storage of a cleaner preparation comprising bleach particles.

In another embodiment of the invention, the bleach particles can have an additional coating layer which is positioned on top of the outer coating layer and comprises an alkali metal silicate with an SiO₂ to alkali metal oxide modulus of more than 2.5 as main constituent. This additional coating layer comprises, as main constituent, an alkali metal silicate if it does not comprise any further component in a weight fraction which is larger than the fraction of alkali metal silicate. The modulus of the alkali metal silicate is preferably in the range from 3 to 5 and particularly preferably in the range from 3.2 to 4.2. The fraction of the additional coating layer in the bleach particles according to the invention is preferably in the range from 0.2 to 3% by weight. The fraction of alkali metal silicate in the material of the additional coating layer is preferably more than 50% by weight and particularly preferably more than 80% by weight. The alkali metal silicate used in the additional coating layer is preferably sodium silicate and particularly preferably sodium waterglass. Bleach particles according to the invention with an additional coating layer, which comprises, as main constituent, an alkali metal silicate with an SiO₂ to alkali metal oxide modulus of more than 2.5, additionally show a delayed dissolution time in water and an improved storage stability in water-containing liquid or gel-like media at water contents of up to 15% by weight. They can therefore be used advantageously for producing liquid or gel-like detergent or cleaner preparations.

In a further embodiment of the invention, the bleach particles according to the invention can have on their surface additionally 0.01 to 1% by weight, preferably 0.1 to 0.5% by weight, of a finely divided oxide of the elements Si, Al or Ti or of a mixed oxide of these elements. Suitable finely divided oxides are, for example, pyrogenic oxides which are obtained by flame hydrolysis of volatile compounds of the elements silicon, aluminum or titanium or of mixtures of these compounds. The pyrogenic oxides or mixed oxides obtainable in this way preferably have a mean primary particle size of less than 50 nm and can be aggregated to give larger particles, the mean particle size of which is preferably less than 20 μm. Precipitated oxides which have been precipitated from aqueous solutions of compounds of the elements silicon, aluminum or titanium or mixtures of these compounds are likewise suitable. Besides silicon, aluminum and/or titanium, the precipitated oxides or mixed oxides can also comprise small amounts of alkali metal ions or alkaline earth metal ions. The mean particle size of the precipitated oxides is preferably less than 50 μm and particularly preferably less than 20 μm. The specific surface area of the finely divided oxides according to BET is preferably in the range from 100 to 300 m²/g. Preferably, the bleach particles have on their surface a hydrophobized finely divided oxide and particularly preferably a hydrophobized fumed or precipitated silica. Within the context of the invention, hydrophobized oxides are oxides which, on their surface, have organic radicals bonded via chemical bonds and are not wetted by water. Hydrophobized oxides can be produced, for example, by reacting pyrogenic or precipitated oxides with organosilanes, silazanes or polysiloxanes. Suitable silicon compounds for producing hydrophobized oxides are known from EP-A 0 722 992, page 3, line 9 to page 6, line 6. Particular preference is given to hydrophobized oxides which have been prepared by reacting a finely divided oxide with a silicon compound from compound classes (a) to (e) and (k) to (m) listed in EP-A 0 722 992. The hydrophobized finely divided oxides preferably have a methanol wettability of at least 40. Bleach particles according to the invention which additionally have a finely divided oxide on their surface exhibit a lower tendency towards caking during storage, primarily during storage under compressive load and therefore have better silo storability. Moreover, such particles have increased storage stability in cleaners.

Preferably, the core of the bleach particles according to the invention has an essentially spherical shape with a smooth interface to the inner coating layer positioned on top. The average roughness Rₐ of the interface between core and inner coating layer is preferably less than 5 μm, determined by SEM images with material contrast for interfacial sections of 100 μm in length on cut surfaces of the particles.

The inner coating layer preferably has a homogeneous coating thickness, the thickness of the inner coating layer for more than 90% of the layer deviating by less than 50% from the average layer thickness.

The bleach particles according to the invention show an unexpectedly high storage stability even though they comprise sodium percarbonate and a perhydrolyzable bleach activator within the same particle, which may react with one another with considerable release of heat. The release of heat of the bleach particles according to the invention, determined by TAM measurement by means of Thermal Activity Monitor from Thermometric AB, Järfälla (Sweden), is preferably less than 15 μW/g and particularly preferably less than 10 μW/g after storage at 40° C. for 48 h. After storage for 48 h at 50° C., the release of heat is preferably less than 30 μW/g and particularly preferably less than 12 μW/g. The high storage stability and small release of heat permits storage of the bleach particles according to the invention in large silos without the risk of self-accelerating decomposition of the material stored in the silo. Moreover, it permits safe transportation and safe handling of the bleach particles under climatically demanding conditions in hot and humid regions.

The invention further provides a cleaner which comprises bleach particles according to the invention. Preferably, the cleaner is a detergent for the washing of textiles, an additional bleach for detergents or a dishwashing detergent for the machine washing of dishes, particularly preferably a detergent for the washing of textiles. The cleaner according to the invention comprises the bleach particles according to the invention preferably in an amount of from 1 to 50% by weight, based on the total amount of the cleaner.

The cleaner according to the invention may be in solid form and may then also comprise further components in the form of powder or in the form of granules beside the inventive coated sodium percarbonate particles. Furthermore, they may also comprise press-shaped bodies, in which case the bleach particles according to the invention may be part of the press-shaped bodies. Such press-shaped bodies in the form of extrudates, pellets, briquettes or tablets can be produced by processes for pressing agglomeration, especially by extrusion, strand pressing, perforation pressing, roller compaction or tabletting. For the performance of the pressing agglomeration, the cleaner according to the invention may additionally comprise a binder which imparts a higher strength to the shaped bodies in the course of pressing agglomeration. However, for a cleaner according to the invention which comprises press-shaped bodies preference is given to not using any additional binder and one of the wash-active constituents, for example a nonionic surfactant, fulfils the function of the binder.

The cleaner according to the invention may additionally also be in liquid form or gel form and comprise the bleach particles according to the invention dispersed in a liquid phase, or a gel phase. In addition to the bleach particles according to the invention, further particles may be dispersed in the liquid phase or the gel phase. The rheological properties of the liquid phase, or of the gel phase, are preferably adjusted such that the particles dispersed therein remain suspended and do not settle during storage. The composition of a liquid phase is preferably selected in such a way that it has thixotropic or pseudoplastic flow properties. To establish such flow properties, suspension auxiliaries, such as swelling clays, especially montmorillonites, precipitated and fumed silicas, vegetable gums, especially xanthans, and polymeric gelling agents, such as vinyl polymers containing carboxyl groups, may be added.

Cleaners according to the invention in liquid form or gel form preferably comprise bleach particles according to the invention with an additional coating layer which comprises, as main constituent, an alkali metal silicate with an SiO₂ to alkali metal oxide modulus of more than 2.5. In this embodiment, the cleaners may comprise up to 15% by weight of water without this resulting in a partial dissolution of the bleach particles and an associated release of hydrogen peroxide or peroxycarboxylic acid into the liquid phase or gel phase during storage.

Besides the bleach particles according to the invention, the cleaner according to the invention can comprise, as further components, also surfactants, builders, alkaline components, enzymes, chelating complexing agents, graying inhibitors, foam inhibitors, optical brighteners, fragrances and dyes.

Suitable surfactants for the cleaner according to the invention are in particular anionic, nonionic and cationic surfactants.

Suitable anionic surfactants are, for example, surfactants with sulfonate groups, preferably alkylbenzenesulfonates, alkanesulfonates, alpha-olefinsulfonates, alpha-sulfo fatty acid esters or sulfosuccinates. In the case of alkylbenzenesulfonates, preference is given to those having a straight-chain or branched alkyl group having from 8 to 20 carbon atoms, especially having from 10 to 16 carbon atoms. Preferred alkanesulfonates are those with straight alkyl chains having from 12 to 18 carbon atoms. In the case of alpha-olefinsulfonates, preference is given to the reaction products of the sulfonation of alpha-olefins having from 12 to 18 carbon atoms. In the case of the alpha-sulfo fatty acid esters, preference is given to sulfonation products of fatty acid esters formed from fatty acids having from 12 to 18 carbon atoms and short-chain alcohols having from 1 to 3 carbon atoms. Suitable anionic surfactants also include surfactants having a sulfate group in the molecule, preferably alkyl sulfates and ether sulfates. Preferred alkyl sulfates are those with straight-chain alkyl radicals having from 12 to 18 carbon atoms. Also suitable are beta-branched alkyl sulfates and alkyl sulfates mono- or poly-alkyl-substituted in the middle of the longest alkyl chain. Preferred ether sulfates are the alkyl ether sulfates which are obtained by ethoxylating linear alcohols having from 12 to 18 carbon atoms with from 2 to 6 ethylene oxide units and then sulfating. The anionic surfactants used may finally also be soaps, for example alkali metal salts of lauric acid, myristic acid, palmitic acid, stearic acid and/or natural fatty acid mixtures, for example coconut, palm kernel or tallow fatty acids.

Suitable nonionic surfactants are, for example, alkoxylated compounds, especially ethoxylated and propoxylated compounds. Particularly suitable nonionic surfactants are condensation products of alkylphenols or fatty alcohols with from 1 to 50 mol, preferably from 1 to 10 mol, of ethylene oxide and/or propylene oxide. Likewise suitable are polyhydroxy fatty acid amides in which an organic radical having one or more hydroxyl groups which may also be alkoxylated is bonded to the amide nitrogen. Likewise suitable as nonionic surfactants are alkylglycosides with a straight-chain or branched alkyl group having from 8 to 22 carbon atoms, especially having from 12 to 18 carbon atoms, and a mono- or diglycoside radical, which is preferably derived from glucose.

Suitable cationic surfactants are, for example, mono- and dialkoxylated quaternary amines having a C₆-C₁₈-alkyl radical bonded to the nitrogen and one or two hydroxyalkyl groups.

The cleaner according to the invention generally also comprise builders which are capable of binding calcium and magnesium ions dissolved in water in the course of use. Suitable builders are alkali metal phosphates and alkali metal polyphosphates, especially pentasodium triphosphate; water-soluble and water-insoluble sodium silicates, especially sheet silicates of the formula Na₅Si₂O₅; zeolites of the A, X and/or P structures; and trisodium citrate. In addition to the builders, it is also possible to use organic cobuilders, for example polyacrylic acid, polyaspartic acid and/or acrylic acid copolymers with methacrylic acid, acrolein or vinyl monomers containing sulfonic acid, and the alkali metal salts thereof.

The cleaner according to the invention generally also comprise alkaline components which upon the intended use bring about a pH in the range from 8 to 12 in the aqueous cleaning composition solution. Suitable alkaline components are in particular sodium carbonate, sodium sesquicarbonate, sodium metasilicate and other soluble alkali metal silicates.

The cleaner according to the invention may further comprise enzymes which enhance the cleaning action, especially lipases, cutinases, amylases, neutral and alkaline proteases, esterases, cellulases, mannanases, pectinases, lactases, perhydrolases and/or peroxidases. The enzymes may be adsorbed on carrier substances or be embedded into coating substances in order to protect them from decomposition.

The cleaner according to the invention may also comprise chelating complexing agents for transition metals, with which a catalytic decomposition of active oxygen compounds in the wash liquor, or the aqueous cleaning composition solution, can be prevented. Suitable examples are phosphonates, such as hydroxyethane-1,1-diphosphonate, nitrilotrimethylenephosphonate, diethylenetriaminepenta-(methylenephosphonate), ethylenediaminetetra(methylene-phosphonate), hexamethylenediaminetetra(methylene-phosphonate) and the alkali metal salts thereof. Likewise suitable are nitrilotriacetic acid and polyaminocarboxylic acids, especially ethylenediaminetetraacetic acid, diethylenetriaminopentaacetic acid, ethylenediamine-N,N′-disuccinic acid, methylglycinediacetic acid and polyaspartates, and the alkali metal and ammonium salts thereof. Finally, polybasic carboxylic acids and especially hydroxycarboxylic acids, especially tartaric acid and citric acid, are also suitable as chelating complexing agents.

In the embodiment of a detergent for textiles, the cleaner according to the invention may additionally comprise graying inhibitors which keep soil detached from the fiber suspended and prevent reattachment of the soil to the fiber. Suitable graying inhibitors are, for example, cellulose ethers such as carboxymethylcellulose and the alkali metal salts thereof, methylcellulose, hydroxyethylcellulose and hydroxypropylcellulose. Polyvinylpyrrolidone is likewise suitable.

The cleaner according to the invention may further also comprise foam inhibitors which reduce foam formation. Suitable foam inhibitors are, for example, organopoly-siloxanes such as polydimethylsiloxane, paraffins and/or waxes, and mixtures thereof with fine silicas.

In the embodiment of a detergent for textiles, the cleaner according to the invention may optionally comprise optical brighteners which attach to the fiber, absorb light in the UV range and fluoresce in a blue color in order to compensate for yellowing of the fiber. Suitable optical brighteners are, for example, derivatives of diaminostilbenedisulfonic acid, such as alkali metal salts of 4,4′-bis(2-anilino-4-morpholino-1,3,5-triazinyl-6-amino)stilbene-2,2′-disulfonic acid, or substituted diphenylstyryls, such as alkali metal salts of 4,4′-bis(2-sulfostyryl)diphenyl.

Finally, the cleaner according to the invention may also comprise fragrances and dyes.

A cleaner according to the invention in liquid form or gel form may additionally also comprise up to 30% by weight of organic solvents, such as, for example, methanol, ethanol, n-propanol, isopropanol, n-butanol, ethylene glycol, 1,2-propylene glycol, 1,3-propylene glycol, 1,4-butylene glycol, glycerol, diethylene glycol, ethylene glycol methyl ether, ethanolamine, diethanolamine and/or triethanolamine.

Compared with cleaners which, instead of the bleach particles according to the invention, comprise prior art bleach particles comprising sodium percarbonate and a bleach activator, the cleaner according to the invention exhibits better storage stability with lower losses of active oxygen content and bleaching performance upon storage under humid conditions.

The bleach particles according to the invention can be produced using the method according to the invention which comprises at least two steps. In the first step of the method according to the invention, an aqueous solution comprising sodium sulfate is sprayed onto a particle consisting essentially of sodium percarbonate with simultaneous evaporation of water. In the second step of the method according to the invention, an aqueous solution or dispersion of a water-soluble binder and particles of a bleach activator, selected from perhydrolyzable N-acyl compounds and O-acyl compounds, are then deposited on the coated particles formed in the first step. By using an aqueous solution or dispersion of the binder, a more uniform thickness of the outer coating layer is achieved compared with using molten binder, and agglomeration of the bleach particles is avoided, so that bleach particles with a narrower particle size distribution can be produced.

In the first step of the method according to the invention, during the spray application of the aqueous solution which comprises dissolved sodium sulfate, the majority of the water present therein, especially more than 90% of the water present in the aqueous solution, is preferably already evaporated as a result of supply of heat, such that only a small portion of the core is partly dissolved and a solid coating layer forms already during the spray application. The inner coating layer is applied preferably by spraying an aqueous solution comprising sodium sulfate in a fluidized bed and more preferably by the process described in EP-A 0 970 917, with which it is possible to achieve a dense coating layer even with small amounts of coating layer material. The application of the inner coating layer in a fluidized bed preferably takes place with the introduction of a drying gas to the fluidized bed such that a temperature in the range from 30 to 90° C., preferably 45 to 70° C., is established in the fluidized bed. The drying gas used is preferably heated air or a mixture of air and a combustion gas, the combustion gas used preferably being a combustion gas obtained by combustion of natural gas with air. The dust discharged with the drying gas during application of the inner coating layer in a fluidized bed is preferably used for producing the aqueous solution comprising sodium sulfate, which is used for applying the inner coating layer.

In the second step of the method according to the invention, the aqueous solution or dispersion of the binder and the particles of a bleach activator can be deposited simultaneously or successively on the coated particles obtained in the first step. The aqueous solution or dispersion of the binder and the particles of a bleach activator can be deposited separately from one another. Likewise, the particles of the bleach activator can also be deposited suspended in the aqueous solution or dispersion of the binder.

Preferably, the second step of the method according to the invention is carried out in a fluidized bed with simultaneous evaporation of water. The aqueous solution or dispersion of the binder is then sprayed into a fluidized bed preferably via a nozzle, particularly preferably via a two-component or multi-component nozzle with air as propellant gas, said fluidized bed containing the coated particles obtained in the first step, and a drying gas being supplied thereto such that a temperature in the range from 30 to 90° C., preferably 45 to 70° C., is established in the fluidized bed. The particles of the bleach activator can be introduced directly into the fluidized bed as dry powder or be supplied in powder form to a multi-component nozzle used for spraying the aqueous solution or dispersion of the binder. Alternatively, the particles of the bleach activator can be suspended directly prior to spraying in the aqueous solution or dispersion of the binder, the resulting suspension preferably being passed through a dispersing device, in which a shearing of the suspension takes place between a rotor element and a stator element, prior to introduction to the spray nozzle. Suitable dispersing devices are, for example, the inline dispersing devices of the Ultra-Turrax® and Dispax® design series sold by Ika. The dispersing device is preferably configured and operated such that it destroys, in the suspension, agglomerates with a diameter which is more than one third of the minimum channel dimension of the multi-material nozzle used. If the suspension is passed through a central channel of a multi-component nozzle, then the minimal channel dimension refers to the minimal diameter of the central channel. If the suspension is passed through an annular channel of a multi-component nozzle, then the minimal channel dimension refers to the minimal width of the annular gap.

In a preferred embodiment, in a further step following the second step an aqueous solution comprising sodium sulfate is sprayed onto the coated particles formed in the second step with simultaneous evaporation of water. With this further step, a further layer containing sodium sulfate is applied in addition to the inner and outer coating layer. This further step is preferably carried out in a fluidized bed, the fluidized bed being particularly preferably operated as described previously for the first step, except for using the dust discharged with the drying gas.

In a preferred embodiment of the method according to the invention, the bleach particles, are dried at a temperature in the range from 60 to 95° C., preferably in the range from 70 to 90° C., after applying an outer coating layer in the second step of the method, the drying preferably taking place for at least 2 min and particularly preferably taking place for 4 to 20 min. If an additional coating layer is applied after the second step, the drying preferably takes place after applying the additional coating layer.

The examples below illustrate the invention without, however, limiting the subject matter of the invention.

### EXAMPLES

For examples 1 to 13, a coated sodium percarbonate was used which was coated with 7% by weight of a coating layer which had been prepared by spraying an aqueous solution, comprising 23.0% by weight of sodium sulfate and 3.4% by weight of sodium carbonate, in a fluidized bed onto a sodium percarbonate prepared by fluidized-bed buildup granulation. The coated sodium percarbonate used had an active oxygen content of 13.2%, corresponding to a content of sodium percarbonate of 86.4% by weight, a bulk density of 1120 g/l, a weight-based average particle size of 820 μm, a width of the particle size distribution (span) calculated as (d₉₀−d₁₀)/d₅₀ of 0.82 and a release of heat in the TAM test after storage for 48 h at 40° C. of 2.3 μW/g.

### Example 1

The experiment was carried out in a Mycrolab fluidized-bed coater from OYSTAR Huttlin, which was equipped with a 1 l product container and a three-component nozzle installed from the bottom and was operated with subatmospheric pressure in the fluidized bed and 35 m³/h (STP) air of 80° C. as fluidizing gas.

The binder used was sodium polyacrylate with an average molecular weight of 1900 g/mol in the form of a 45% by weight aqueous solution. The bleach activator used was TAED from Wfk, which was triturated in a mortar and from which coarse particles were removed by sieving through a sieve with a mesh size of 200 μm.

400 g of coated sodium percarbonate were charged to the preheated fluidized-bed coater and heated to a fluidized-bed temperature of 45° C. The binder solution was then sprayed into the fluidized bed via the three-component nozzle at a spraying rate of 3.75 g/min and a spraying pressure of 0.8 bar, resulting in a fluidized-bed temperature of 55° C., and, at intervals of in each case 5 min, 5 portions each of 20 g of TAED were introduced as powder into the fluidized bed by suction. After adding the last portion of TAED and spraying a total of 100 g of binder solution, 50 g of sodium sulfate in the form of a 25% by weight aqueous solution were sprayed on via the same spraying nozzle at a spray rate of 6 g/min, resulting in a fluidized-bed temperature of 45° C. Post-drying was then carried out for a further 5 min in the fluidized-bed coater, during which the fluidized-bed temperature increased to 65° C., and the product was then dried in a drying cabinet for 1 h at 80° C.

The bleach particles produced in this way had an active oxygen content of 10.0%, corresponding to a content of sodium percarbonate of 65.4% by weight, a content of TAED of 12.1% by weight, a bulk density of 880 g/l, a weight-based average particle size of 940 μm, a width of the particle size distribution (span) of 0.84 and a release of heat in the TAM test after storage for 48 h at 40° C. of 5.3 μW/g.

### Examples 2 to 4

TAED AC white from Clariant was comminuted in a laboratory mill model A10 from Ika in 40 g portions for 30 s in each case. 400 g of coated sodium percarbonate were placed into a food processor model K3000 type 3210 from Braun, equipped with stainless steel container and kneading tool, and, at maximum speed, the amount of binder stated in table 1 was added dropwise and, in parallel to this, 200 g of the comminuted TAED were added in portions of 20 g. When the addition was complete, mixing was carried out for a further 2 min and the mixture was introduced by suction into a fluidized-bed coater model Mycrolab from OYSTAR Huttlin which was equipped with a 1 l product container and a two-component nozzle built in from below and having the construction described in DE 38 06 537 A1 and was operated at subatmospheric pressure in the fluidized bed and with 35 Nm³/h [STP] of air at 80° C. as fluidizing gas. As soon as the temperature in the fluidized bed had increased to 60° C., 250 g of a 25% by weight aqueous sodium sulfate solution were sprayed on at a spraying rate of 6 g/min at a fluidized-bed temperature of 60° C. Post-drying was then carried out for 5 min in the fluidized bed, during which the temperature increased to 75° C. and the product was then dried in a drying cabinet for 1 h at 85° C.

The analyzed contents of active oxygen and TAED, the release of heat in the TAM test after storage for 48 h at 40° C. or 50° C. and the dissolution time in water are listed in table 1. To determine the dissolution time, 2.5 g of sodium percarbonate particles were dissolved at 20° C. in 1 l of water in a thermostated measuring cell made of glass (diameter 130 mm, height 150 mm) with stirring using a magnetic stirrer. The stirring speed was selected such that a vortex funnel 4 cm in depth was formed. During the dissolution operation, the change in the electrical conductivity of the solution was measured. The dissolution time is the time in which 90% of the final conductivity is reached.

### Example 5

Example 2 was repeated except that after the spraying-on of the sodium sulfate solution and before the post-drying in the fluidized bed, 34 g of a 10% strength by weight aqueous sodium silicate solution with a modulus of 3.3 was sprayed on through the same nozzle and at the same spraying rate.

TABLE 1

| | | AO | TAED | | | Disso- |
|---|---|---|---|---|---|---|
| Ex- | | content | content | TAM | TAM | lution |
| am- | | in % by | in % by | 40° C. | 50° C. | time |
| ple | Binder | weight | weight | in μW/g | in μW/g | in min |
| 2 | 60 g Acusol* | 8.4 | 24.6 | 1.8 | 4.4 | 103 |
| 3 | 60 g Acusol* + | 7.8 | 24.1 | 1.9 | 5.9 | 120 |
| | 20 g waterglass** | | | | | |
| 4 | 68 g waterglass** | 8.6 | 23.1 | 8.5 | 27.8 | 79 |
| 5 | 60 g Acusol* | 8.2 | 26.0 | 1.5 | 4.3 | 174 |

*Acusol ™ 445 N (sodium polyacrylate Mw 4500 g/mol), 45% by weight aqueous solution
**36% by weight aqueous sodium silicate solution, modulus 3.3

### Examples 6 to 10

In each case 400 g of TAED AC white from Clariant were comminuted in a food processor model K3000 type 3210 from Braun, equipped with universal plastic container and chopping knives, at maximum speed for 30 to 45 s. Particles with a size greater than 400 μm were removed from the comminuted material by sieving with a sieving machine model Jelxix 50 from Retsch using a sieve with a 400 μm mesh width. Coated sodium percarbonate was introduced into the same food processor, equipped with stainless steel container and kneading tool, in the amount stated in table 2. The amount of Acusol listed in table 2 was diluted with the same amount of water and, at maximum speed, 10 g of the diluted solution were sprayed on over the course of 10 s. One portion of the comminuted TAED was then slowly metered in according to the quantitative ratio of TAED to Acusol from table 2, and the steps of spraying-on of Acusol solution and metered addition of TAED were repeated until the total amount of binder and TAED had been applied. Mixing was then carried out for a further 2 min at maximum speed and then agglomerates were removed from the resulting material by sieving using a sieve with a 1600 μm mesh width. An additional coating layer of sodium sulfate was applied to the sieved material as in examples 2 to 4 in the amount given in table 2.

The analyzed contents of active oxygen and TAED, the release of heat in the TAM test following storage for 48 h at 40° C. or 50° C. and the dissolution time in water are listed in table 2.

TABLE 2

| | | | | | AO | TAED | | | |
|---|---|---|---|---|---|---|---|---|---|
| | | | | | content | content | TAM | TAM | |
| | NaPC | TAED | Acusol* | Na₂SO₄ | in % by | in % by | 40° C. in | 50° C. in | Dissolution |
| Example | in g | in g | in g | in g | wt. | wt. | μW/g | μW/g | time in min |
| 6 | 450 | 450 | 77 | 90 | 5.9 | 37.0 | 1.0 | 3.2 | 46 |
| 7 | 900 | 450 | 120 | 157 | 8.6 | 25.5 | 3.0 | 9.9 | 55 |
| 8 | 996 | 332 | 100 | 150 | n.d. | n.d. | n.d. | 7.6 | n.d. |
| 9 | 1080 | 270 | 72 | 157 | 9.7 | n.d. | 1.7 | 4.6 | 55 |
| 10 | 1665 | 335 | 30 | 212 | 9.8 | 15.7 | 3.6 | 6.4 | 59 |

NaPC sodium percarbonate
*Acusol ™ 445 N (sodium polyacrylate Mw 4500 g/mol), 45% by weight solution in water
n.d. not determined

### Examples 11 and 12

In examples 11 and 12, example 9 was repeated except that in example 11 no additional coating layer made of sodium sulfate was applied and in example 12 no post-drying in the fluidized-bed and in the drying cabinet was carried out after applying the additional coating layer.

The product obtained in example 11 exhibited a release of heat in the TAM test after storage for 48 h at 40° C. of 12.3 μW/g.

The product obtained in example 12 exhibited a release of heat in the TAM test after storage for 48 h at 40° C. of 5.5 μW/g.

### Example 13

TAED was comminuted and sieved as in examples 6 to 12. 1125 g of coated sodium percarbonate were introduced into a plowshare mixer model M5R from Lödige. At a mixing speed of 190 min⁻¹, 82 g of Acusol™ 445 N, diluted with the same amount of water, and also 375 g of comminuted TAED were applied in the same manner as in examples 6 to 10 and mixed for a further 2 min at the same speed. Agglomerates were removed from the resulting material by sieving using a sieve with a 1600 μm mesh width. An additional coating layer made of 166 g of sodium sulfate was applied to the sieved material as in examples 2 to 4.

The analyzed contents of active oxygen and TAED and the release of heat in the TAM test after storage for 48 h at 50° C. are listed in table 3.

### Example 14

### Not According to the Invention

Example 13 was repeated except that 1600 g of sodium percarbonate produced in the same manner by fluidized-bed granulation was used which had no coating layer made of sodium sulfate and sodium carbonate, in the plowshare mixer a coating layer of 400 g of TAED and 100 g of Acusol™ 445 N was applied and then an additional coating layer of 222 g of sodium sulfate was applied. The analyzed contents of active oxygen and TAED and the release of heat in the TAM test after storage for 48 h at 50° C. are listed in table 3.

### Example 15

Example 13 was repeated except that a sodium percarbonate was used which had a coating layer of 7% by weight sodium sulfate (based on the weight of the singly coated sodium percarbonate) instead of the coating layer of sodium sulfate and sodium carbonate, in the plowshare mixer a coating layer of 375 g of TAED and 134 g of Acusol™ 445 N was applied and then an additional coating layer of 166 g of sodium sulfate was applied. The analyzed contents of active oxygen and TAED and the release of heat in the TAM test after storage for 48 h at 50° C. are listed in table 3.

TABLE 3

| | AO content | TAED content | TAM 50° C. |
|---|---|---|---|
| Example | in % by weight | in % by weight | in μW/g |
| 13 | 9.0 | 20.1 | 6.6 |
| 14* | 10.7 | 13.3 | 98 |
| 15 | 8.8 | 20.8 | 9.3 |

*not according to the invention

1-17. (canceled)

18. A bleach particle comprising:
a) a core consisting essentially of sodium percarbonate,
b) an inner coating layer comprising at least 50% by weight of sodium sulfate in the form of thenardite or burkeite, and
c) an outer coating layer comprising a water-soluble binder and at least one bleach activator selected from the group consisting of perhydrolyzable N-acyl compounds and O-acyl compounds.

19. The bleach particle of claim 18, wherein the core is a sodium percarbonate particle obtainable by fluidized-bed buildup granulation.

20. The bleach particle of claim 18, wherein the core has a diameter in the range of from 400 to 1600 μm.

21. The bleach particle of claim 18, wherein the inner coating layer comprises sodium sulfate and sodium carbonate in a weight ratio of from 95:5 to 75:25 and the fraction of sodium sulfate and sodium carbonate in the coating layer is at least 80% by weight.

22. The bleach particle of claim 18, wherein the weight fraction of the inner coating layer is 2 to 25%, based on the mass of the bleach particle.

23. The bleach particle of claim 18, wherein the weight fraction of the inner coating layer is 2 to 10%, based on the mass of the bleach particle.

24. The bleach particle of claim 18, wherein the outer coating layer comprises the bleach activator in the form of particles with an average particle size in the range of from 0.1 to 400 μm.

25. The bleach particle of claim 18, wherein the bleach activator is tetraacetylethylenediamine or the sodium salt of 4-nonanoyloxybenzenesulfonic acid.

26. The bleach particle of claim 18, wherein the binder is a water-soluble alkali metal silicate or a vinyl polymer with carboxyl groups.

27. The bleach particle of claim 18, wherein the weight ratio of bleach activator to sodium percarbonate is in the range of from 1:1 to 1:9.

28. The bleach particle of claim 18, wherein the weight ratio of bleach activator to sodium percarbonate is in the range of from 1:3 to 1:5.

29. The bleach particle of claim 18, wherein the weight ratio of bleach activator to binder is in the range of from 20:1 to 1:1.

30. The bleach particle of claim 18, wherein the bleach particle further comprises an additional coating layer which is positioned on top of the outer coating layer and comprises at least 50% by weight of sodium sulfate in the form of thenardite or burkeite.

31. The bleach particle of claim 30, wherein the weight fraction of the additional coating layer is 2 to 25% based on the mass of the bleach particle.

32. The bleach particle of claim 30, wherein the weight fraction of the additional coating layer is 2 to 10% based on the mass of the bleach particle.

33. A cleaner comprising bleach particles according to claim 18.

34. A method of producing bleach particles according to claim 18, comprising
a) spraying an aqueous solution comprising sodium sulfate onto particles consisting essentially of sodium percarbonate, with simultaneous evaporation of water and
b) depositing an aqueous solution or dispersion of a water-soluble binder and particles of a bleach activator, selected from the group consisting of perhydrolyzable N-acyl compounds and O-acyl compounds, on the coated particles formed in step a).

35. The method of claim 34, wherein step b) is carried out in a fluidized bed with simultaneous evaporation of water.

36. The method of claim 34, further comprising step c), in which an aqueous solution comprising sodium sulfate is sprayed onto the coated particles formed in step b) with simultaneous evaporation of water.

37. The method of claim 34, wherein, after applying an outer coating layer in step b), drying is carried out at a temperature in the range of from 60 to 95° C.
